(19) United States
(12) Patent Application Publication
(10) Pub. No.: US 2026/0170702 A1
(43) Pub. Date: Jun. 18, 2026

(54) COMPUTER SYSTEM, VIDEO DATA COMPRESSION METHOD, AND PROGRAM

(71) Applicant: Hitachi Vantara, Ltd., Yokohama-shi (JP)

(72) Inventors: Akifumi SUZUKI, Tokyo (JP); Takahiro NARUKO, Tokyo (JP); Hiroaki AKUTSU, Tokyo (JP)

(21) Appl. No.: 19/324,283

(22) Filed: Sep. 10, 2025

(30) Foreign Application Priority Data
Dec. 12, 2024 (JP) 2024-217745

(51) Int. Cl. G06T 9/20; G06T 7/20; G06V 20/70

(52) U.S. Cl. CPC G06T 9/20; G06T 7/20; G06V 20/70

(57) ABSTRACT

A computer system includes at least one computing device and a storage device, the storage device stores video data including a plurality of frames, and at least one object is included in the frame. The computing device analyzes a motion characteristic of the object in the video data, controls execution of processing of generating annotation data indicating a position of an important object included in the frame based on a result of the analysis, and compresses the frame using the annotation data such that a data amount of a region in which the important object is present is large and a data amount of a region in which the important object is not present is small.

### CLAIM OF PRIORITY

The present application claims priority from Japanese patent application JP 2024-217745 filed on December 12, 2024, the content of which is hereby incorporated by reference into this application.

### BACKGROUND OF THE INVENTION

### 1. Field of the Invention

The present invention relates to a compression technique for reducing a volume of video data.

### 2. Description of Related Art

From the viewpoint of cost reduction required for accumulation and transfer of video data, a lossy compression technique with a high compression ratio is required. The lossy compression technique requires high efficiency from the viewpoint of reducing the calculation cost required for compression, in addition to the high compression ratio.

A technique is known in which a deep neural network (DNN) such as an autoencoder is used to control a bit allocation amount for each region based on the importance of each region of multidimensional data and to generate compressed data (paragraphs 0169 to 0178 in PTL 1).

### Citation List

### Patent Literature

PTL 1: JP2020-155071A

### SUMMARY OF THE INVENTION

Processing of determining the presence or absence of an important object for all frames is high in processing cost, which is a bottleneck in compression processing. An object of the invention is to provide a technique for compressing data at high speed in a shorter time than when determining presence or absence of an important object for every frame by adjusting the execution of the processing of determining the presence or absence of the important object.

A representative example of the invention disclosed in the present application is as follows. That is, a computer system includes: at least one computing device; and a storage device connected to the at least one computing device, in which the storage device stores video data including a plurality of frames, the frame includes at least one object, and the at least one computing device analyzes a motion characteristic of the object in the video data, controls execution of processing of generating annotation data indicating a position of an important object included in the frame based on a result of the analysis, and compresses the frame using the annotation data such that a data amount of a region in which the important object is present is large and a data amount of a region in which the important object is not present is small.

According to the invention, the data can be compressed at high speed in a shorter time than when determining presence or absence of an important object for every frame by adjusting the execution of the processing of determining the presence or absence of the important object. Problems, configurations, and effects other than those described above will be clarified by description of the following embodiments.

### BRIEF DESCRIPTION OF THE DRAWINGS

FIG. 1 is a flowchart illustrating an outline of the invention;

FIG. 2 is a diagram illustrating an example of a configuration of a system according to Embodiment 1;

FIG. 3 is a diagram illustrating an example of a configuration of a compression system according to Embodiment 1;

FIG. 4 is a diagram illustrating an example of a functional configuration of a compression service unit according to Embodiment 1;

FIG. 5A is a diagram illustrating an example of compression setting information stored in a compression setting database according to Embodiment 1;

FIG. 5B is a diagram illustrating an example of the compression setting information stored in the compression setting database according to Embodiment 1;

FIG. 6 is a diagram illustrating an example of an interface presented by a setting unit according to Embodiment 1;

FIG. 7 is a diagram illustrating a flow of compression processing on video data of the compression system according to Embodiment 1;

FIG. 8 is a flowchart illustrating an example of processing executed by an annotation control unit according to Embodiment 1;

FIG. 9 is a flowchart illustrating an example of processing executed by an annotation data generation unit according to Embodiment 1;

FIG. 10 is a diagram illustrating an example of a configuration of a compression system according to Embodiment 2;

FIG. 11 is a diagram illustrating a flow of compression processing on video data of the compression system according to Embodiment 2;

FIG. 12 is a flowchart illustrating an example of processing executed by an annotation control unit according to Embodiment 3;

FIG. 13 is a flowchart illustrating an example of processing executed by an annotation data generation unit according to Embodiment 3;

FIG. 14 is a diagram illustrating an example of a data structure of frequency adjustment information according to Embodiment 4;

FIG. 15 is a flowchart illustrating an example of processing executed by an annotation control unit according to Embodiment 4;

FIG. 16 is a flowchart illustrating an example of processing executed by an annotation data generation unit according to Embodiment 4;

FIG. 17 is a diagram illustrating an example of a data structure of frequency adjustment information according to Embodiment 5; and

FIG. 18 is a flowchart illustrating an example of processing executed by an annotation control unit according to Embodiment 5.

### DESCRIPTION OF EMBODIMENTS

Hereinafter, embodiments of the invention will be described with reference to the drawings. However, the invention is not to be construed as being limited to the description of the following embodiments. It will be easily understood by those skilled in the art that a specific configuration can be changed without departing from the spirit or scope of the invention.

In configurations of the invention to be described below, the same or similar configurations or functions are denoted by the same reference numerals, and redundant descriptions will be omitted.

The outline of the invention will be described.

A compression system according to the invention is a system that compresses video data, and includes an annotation data generation unit, an annotation control unit, and an encoder as functional configurations. The video data includes a plurality of frames. The frame includes a person, an artifact such as a vehicle, a package, or a sign, and a natural object such as a tree or a mountain as objects.

The annotation data generation unit generates annotation data indicating a position of an important object included in frames constituting the video data. The important object is an object designated by a user. The annotation control unit controls execution of annotation data generation processing. The encoder compresses the frame using the annotation data.

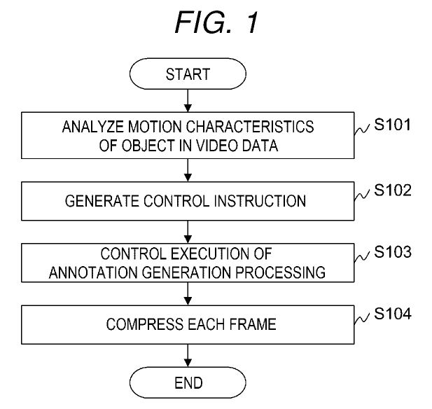

FIG. 1 is a flowchart illustrating an outline of the invention.

The annotation control unit analyzes the motion characteristics of an object in the video data (step S101). Here, the motion characteristics of the object represent the degree of motion of the object included in the frame.

The annotation control unit generates a control instruction based on an analysis result (step S102). The annotation control unit transmits the control instruction to the annotation data generation unit.

Here, the control instruction is information for controlling execution of the annotation data generation processing. When the degree of motion of the object between frames is small, the annotation data can be diverted. Therefore, the annotation control unit generates the control instruction for executing the annotation data generation processing at intervals of the number of frames according to the degree of motion of the object.

The annotation data generation unit controls the execution of the annotation data generation processing based on the control instruction (step S103).

The encoder uses the annotation data to compress each frame such that a data amount of a region in which the important object is present is large and a data amount of a region in which the important object is not present is small (step S104).

In this way, by controlling the execution of the annotation data generation processing based on the motion characteristics of the object in the video data, an execution frequency of the annotation data generation processing in the compression processing can be reduced. Accordingly, the compression processing can be executed efficiently and at a high speed. By compressing the data, the storage capacity can be reduced, and the cost required for the compression processing can be reduced.

### Embodiment 1

In Embodiment 1, an annotation control unit analyzes motion characteristics of an object in video data based on a motion vector included in a frame constituting the video data, and controls annotation data generation processing.

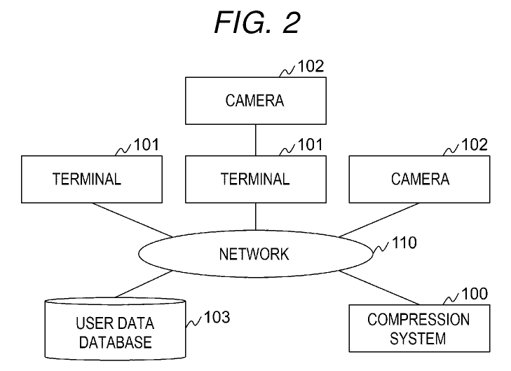

FIG. 2 is a diagram illustrating an example of the configuration of a system according to Embodiment 1.

The system includes a compression system 100, terminals 101, cameras 102, and a user data database 103. The compression system 100 is connected to the terminals 101, the cameras 102, and the user data database 103 via a network 110 such as a local area network (LAN).

The camera 102 generates the video data. It is assumed that the frames constituting the video data include motion vectors. The terminal 101 may generate the video data. In the present embodiment, the following accumulation cases of the video data are assumed. Case 1: The terminal 101 generates the video data and stores the video data in the user data database 103. Case 2: The terminal 101 acquires the video data captured by the camera 102 and stores the video data in the user data database 103. Case 3: The camera 102 stores the video data in the user data database 103.

The user data database 103 is a database that stores user data, such as the video data. The user data database 103 may be implemented using either an on-premises system or a cloud system used by a user.

The compression system 100 compresses the video data stored in the user data database 103 by a lossy compression method. The compression system 100 may be implemented using either an on-premises system or a cloud system used by a user. The compression system 100 may be implemented using a cloud system used by a service provider different from a user who owns the video data, and may be provided as a service.

The compression system 100 may acquire the video data directly from the terminal 101 and the camera 102.

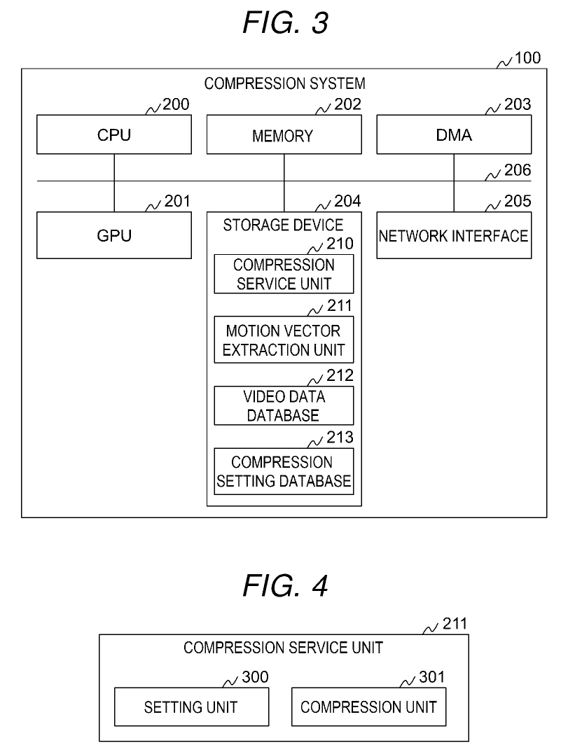

FIG. 3 is a diagram illustrating an example of a configuration of the compression system 100 according to Embodiment 1.

The compression system 100 includes, as a hardware structure, a CPU 200, a GPU 201, a memory 202, a DMA 203, a storage device 204, and a network interface 205. The hardware elements are connected to each other via a bus 206. The number of each hardware element may be two or more.

The CPU 200 and the GPU 201 are computing devices that execute various computing operations. Functional units to be described later are implemented by the CPU 200 or the GPU 201 executing a program.

The memory 202 stores a program executed by the CPU 200 and data used by the program. The DMA 203 is a device that performs DMA transfer. The network interface 205 is a device that performs communication via a network.

The storage device 204 is, for example, a hard disk drive (HDD) or a solid state drive (SSD). The storage device 204 stores programs for implementing a compression service unit 210 and a motion vector extraction unit 211, a video data database 212, and a compression setting database 213.

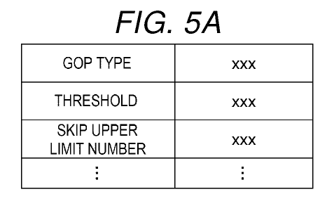

The compression service unit 210 performs various settings related to the compression processing and compresses the video data. FIG. 4 is a diagram illustrating an example of a functional configuration of the compression service unit 210 according to Embodiment 1.

The compression service unit 210 includes a setting unit 300 and a compression unit 301. The setting unit 300 presents an interface for setting a definition of the important object, a compression method, and the like, and performs various settings. The compression unit 301 compresses the video data. The compression unit 301 includes a decoder 401, an annotation control unit 402, an annotation data generation unit 403, and an encoder 404, which will be described later.

The motion vector extraction unit 211 extracts motion vectors included in frames constituting image data.

The video data database 212 stores the video data acquired from the user data database 103. The compression setting database 213 stores various settings for compressing the video data.

The compression setting database 213 stores, for example, important object data including an object type, a frame, and the annotation data. The annotation data is, for example, a monochrome image indicating a region in which the important object in the frame is present.

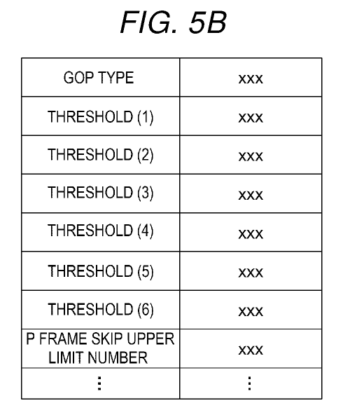

The compression setting database 213 stores compression setting information on a compression method of the video data. FIGS. 5A and 5B are diagrams illustrating examples of the compression setting information stored in the compression setting database 213 according to Embodiment 1.

The compression setting information illustrated in FIG. 5A includes a group of pictures (GOP), a threshold, and a skip upper limit number. The compression setting information illustrated in FIG. 5B includes a GOP, a threshold for each type of frame, and a skip upper limit number. The user can set various types of compression setting information according to the type of the video data.

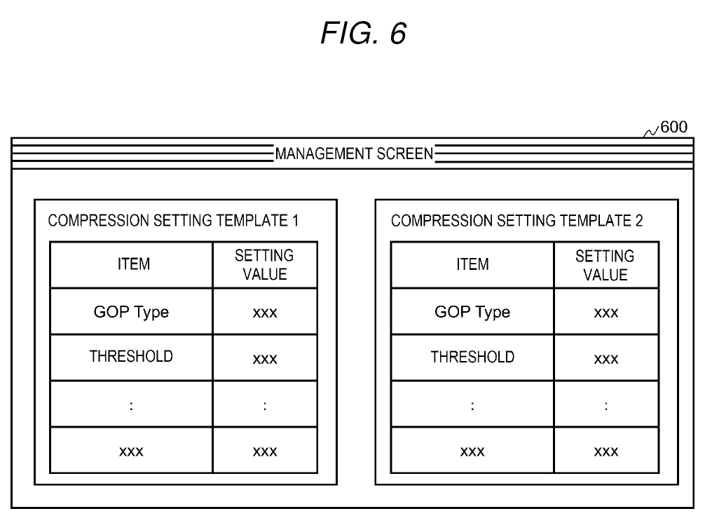

FIG. 6 is a diagram illustrating an example of an interface presented by the setting unit 300 according to Embodiment 1.

The setting unit 300 presents a management screen 600. The user operates the management screen 600 to set the compression setting information. The user can set a plurality of pieces of compression setting information.

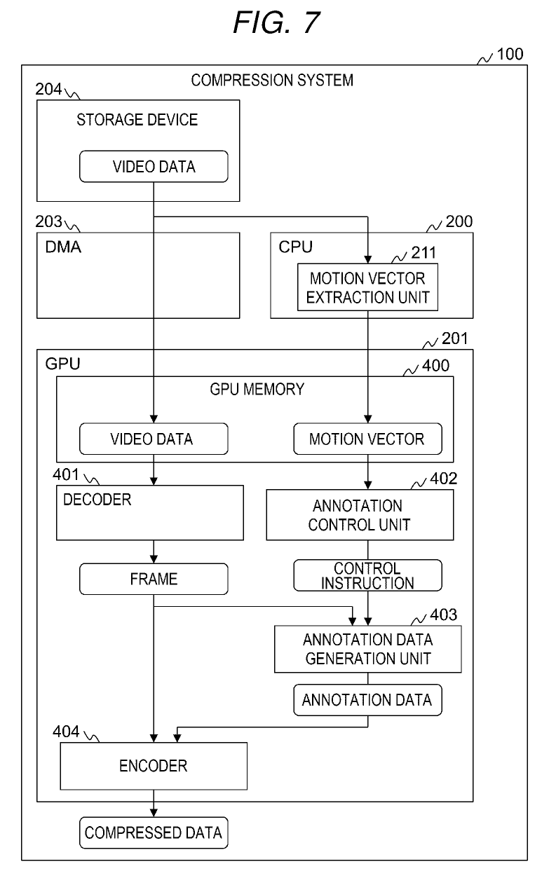

FIG. 7 is a diagram illustrating a flow of the compression processing on the video data of the compression system 100 according to Embodiment 1.

The video data stored in the video data database 212 of the storage device 204 is transmitted to the CPU 200 and is also transmitted to the GPU 201 via the DMA 203.

The CPU 200 executes the program for implementing the motion vector extraction unit 211 and extracts the motion vector included in each of the frames constituting the video data. The CPU 200 transmits the motion vector to which the identification information on the frame is added to the GPU 201.

The GPU 201 stores the video data and the motion vector in a GPU memory 400.

The decoder 401 converts the video data into frames and transmits the frames to the annotation data generation unit 403 and the encoder 404.

The annotation control unit 402 analyzes the motion characteristics of the object in the video data using the motion vector, and determines whether to execute the annotation data generation processing. The annotation control unit 402 transmits the control instruction generated based on a determination result to the annotation data generation unit 403.

The annotation data generation unit 403 determines whether to execute the annotation data generation processing on the received frame based on the control instruction. When executing the annotation data generation processing, the annotation data generation unit 403 executes the annotation data generation processing on the received frame, and transmits the generated annotation data to the encoder 404. When not executing the annotation data generation processing, the annotation data generation unit 403 transmits the annotation data generated in the previous annotation data generation processing to the encoder 404.

The annotation data generation unit 403 generates the annotation data by using a machine learning model generated by, for example, few-shot learning or zero-shot learning. The machine learning model calculates a probability that a pixel is the important object for each pixel of the frame using important object data and the frame as inputs. The annotation data generation unit 403 generates the annotation data based on an output of the machine learning model.

The machine learning model may be prepared for each type of object, and the machine learning model may be switched according to the designated type of object. The machine learning model used in this way does not require an input of the important object data.

The encoder 404 compresses the frames into a predetermined format based on the annotation data and the compression setting information, and outputs compressed data including the compressed frames. The encoder 404 is, for example, an encoder of a standardized video codec such as AVC.

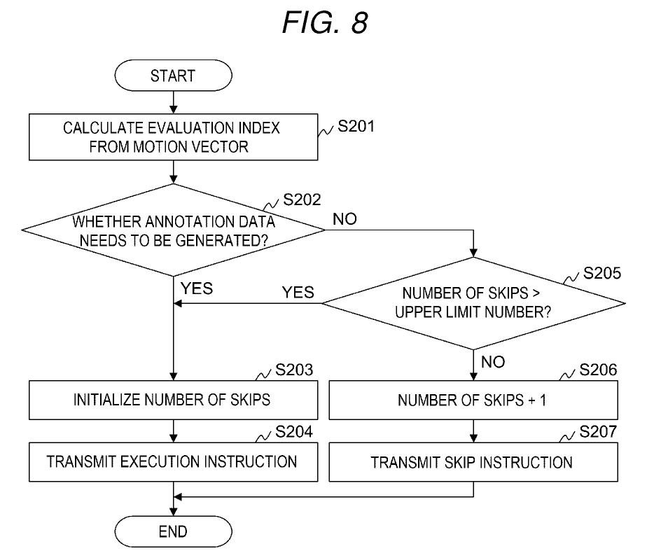

FIG. 8 is a flowchart illustrating an example of the processing executed by the annotation control unit 402 according to Embodiment 1. Hereinafter, the processing will be described using a case in which the compression setting information as illustrated in FIG. 5A is set as an example.

The annotation control unit 402 manages the number of times it is determined that the annotation data does not need to be generated as the number of skips. An initial value of the number of skips is 0.

The annotation control unit 402 calculates an evaluation index using the motion vector included in a frame to be processed (step S201).

For example, the annotation control unit 402 calculates, as the evaluation index, an absolute value of a difference between the motion vector included in the frame to be processed and a motion vector included in a frame immediately before the frame to be processed. The evaluation index described above is merely an example, and the invention is not limited thereto. Any index may be used as long as it can evaluate a magnitude of the motion of the object included in the frames.

When the type of frame is considered, the evaluation index may be calculated using frames of the same type.

The annotation control unit 402 determines whether the annotation data needs to be generated by using the evaluation index (step S202).

Specifically, the annotation control unit 402 determines whether the evaluation index is larger than a threshold included in the compression setting information. If the evaluation index is larger than the threshold, it is determined that the annotation data needs to be generated.

When the type of the frame is considered, the determination may be performed using a threshold corresponding to the type of the frame.

If it is determined that the annotation data needs to be generated, the annotation control unit 402 initializes the number of skips to 0 (step S203), generates an execution instruction for instructing the execution of the annotation data generation processing, and transmits the execution instruction to the annotation data generation unit 403 (step S204). Thereafter, the annotation control unit 402 ends the processing.

If it is determined that the annotation data does not need to be generated, the annotation control unit 402 determines whether the current number of skips is larger than the skip upper limit number included in the compression setting information (step S205).

If the current number of skips is equal to or less than the skip upper limit number, the annotation control unit 402 proceeds to step S203.

If the current number of skips is larger than the skip upper limit number, the annotation control unit 402 adds 1 to the current number of skips (step S206), generates a skip instruction for instructing skip of the annotation data generation processing, and transmits the skip instruction to the annotation data generation unit 403 (step S207). Thereafter, the annotation control unit 402 ends the processing.

The annotation control unit 402 determines whether the motion of the object included in the frame is large based on the evaluation index. If the motion of the object included in the frame is large, the annotation control unit 402 transmits an execution instruction because the important object is likely to move from the previous frame. If the motion of the object included in the frame is small, the annotation control unit 402 transmits the skip instruction because the important object is likely not to move from the previous frame. By controlling the execution of the annotation data generation processing based on the motion vector in this way, the execution frequency of the annotation data generation processing in the compression processing can be reduced.

When the skip of the annotation data generation processing continues for a certain number of times, a probability that a positional deviation of the important object occurs increases. Therefore, when the number of skips is larger than the skip upper limit number, control is performed to execute the annotation data generation processing. The processing of steps S205 to S207 may be omitted.

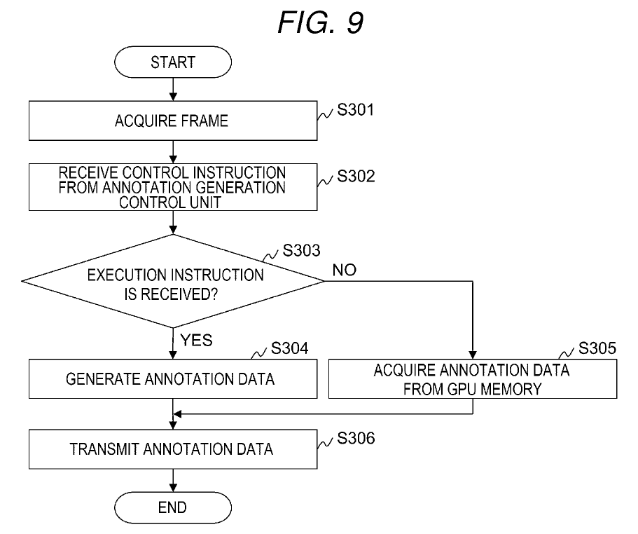

FIG. 9 is a flowchart illustrating an example of processing executed by the annotation data generation unit 403 according to Embodiment 1.

The annotation data generation unit 403 acquires the frame (step S301) and receives the control instruction from the annotation control unit 402 (step S302).

The annotation data generation unit 403 determines whether the received control instruction is an execution instruction (step S303).

If the received control instruction is an execution instruction, the annotation data generation unit 403 generates the annotation data by executing the annotation data generation processing (step S304). Thereafter, the annotation data generation unit 403 proceeds to step S306.

In step S304, the annotation data generation unit 403 stores the annotation data in the GPU memory 400. If the annotation data is stored, the annotation data generation unit 403 overwrites the annotation data.

If the received control instruction is a skip instruction, the annotation data generation unit 403 acquires the previous annotation data from the GPU memory 400 (step S305). Thereafter, the annotation data generation unit 403 proceeds to step S306.

The annotation data generation unit 403 transmits the annotation data to the encoder 404 (step S306). Thereafter, the annotation data generation unit 403 ends the processing.

As described above, the compression system 100 according to Embodiment 1 can analyze the motion characteristics of the object in the video data based on the motion vector included in the frame and control the execution of the annotation data generation processing based on the analysis result.

### Embodiment 2

The Embodiment 2 is different from Embodiment 1 in an extraction method of the motion vector. Hereinafter, Embodiment 2 will be described focusing on a difference from Embodiment 1.

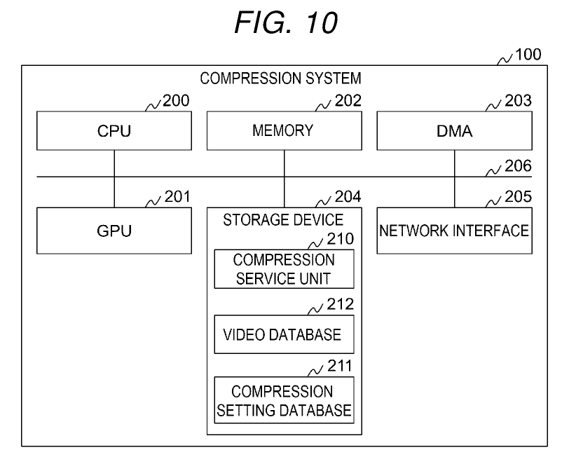

A system configuration according to Embodiment 2 is the same as that in Embodiment 1. FIG. 10 is a diagram illustrating an example of a configuration of the compression system 100 according to Embodiment 2.

A hardware structure of the compression system 100 according to Embodiment 2 is the same as that in Embodiment 1. The compression system 100 according to Embodiment 2 is partially different in software configuration. In Embodiment 2, the decoder 401 includes a function of the motion vector extraction unit 211.

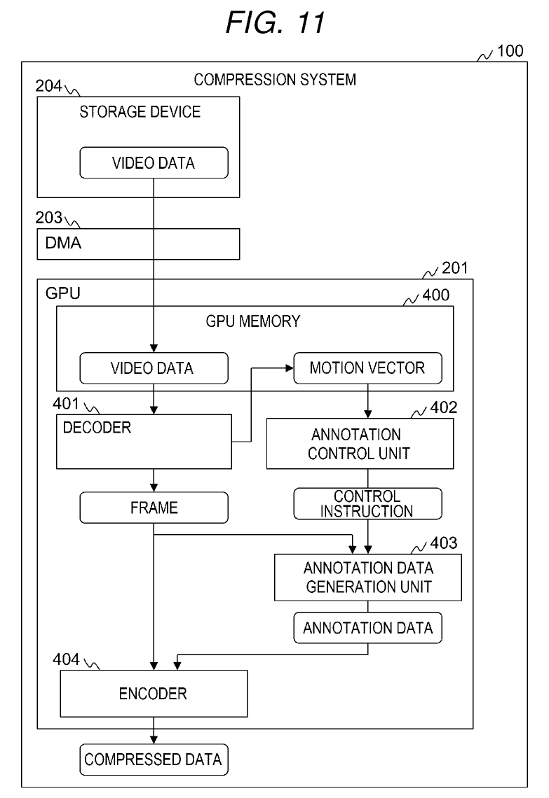

FIG. 11 is a diagram illustrating a flow of compression processing on video data of the compression system 100 according to Embodiment 2.

The video data stored in the video data database 212 of the storage device 204 is transmitted to the GPU 201 via the DMA 203.

The GPU 201 stores the video data in the GPU memory 400.

The decoder 401 converts the video data into frames and extracts a motion vector from the frames. The decoder 401 stores a motion vector to which identification information on the frame is added in the GPU memory 400. The decoder 401 transmits the frames to the annotation data generation unit 403 and the encoder 404.

The annotation control unit 402 analyzes the motion characteristics of the object in the video data using the motion vector, and determines whether to execute the annotation data generation processing. The annotation control unit 402 transmits the control instruction generated based on a determination result to the annotation data generation unit 403.

Based on the control instruction, the annotation data generation unit 403 determines whether the annotation data generation processing needs to be performed on the received frame. If the annotation data generation processing needs to be executed, the annotation data generation unit 403 executes the annotation data generation processing and transmits the generated annotation data to the encoder 404. If the annotation data generation processing does not need to be executed, the annotation data generation unit 403 transmits the annotation data generated in the previous annotation data generation processing to the encoder 404.

The processing executed by the annotation control unit 402 and the annotation data generation unit 403 of Embodiment 2 is the same as that of Embodiment 1.

According to Embodiment 2, since the GPU 201 executes all pieces of processing, the processing load of the CPU 200 can be reduced.

### Embodiment 3

In Embodiment 3, processing executed by the annotation control unit 402 and the annotation data generation unit 403 is partially different. Hereinafter, Embodiment 3 will be described focusing on differences from Embodiment 1.

A system configuration according to Embodiment 3 is the same as that in Embodiment 1. A configuration of the compression system 100 according to Embodiment 3 is the same as that in Embodiment 1. The configuration of Embodiment 2 may be adopted.

A flow of compression processing of Embodiment 3 is the same as that of Embodiment 1. A processing method of Embodiment 2 may be adopted.

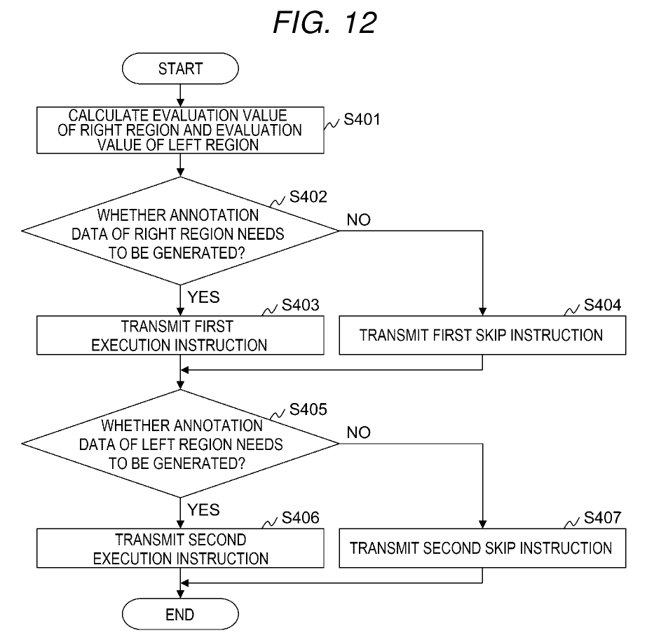

FIG. 12 is a flowchart illustrating an example of the processing executed by the annotation control unit 402 according to Embodiment 3.

The annotation control unit 402 calculates an evaluation index of a right region of a frame to be processed using a motion vector included in the right region, and calculates an evaluation index of a left region of the frame to be processed using a motion vector included in the left region (step S401).

For example, the annotation control unit 402 calculates an absolute value of a difference between the motion vector included in the right region of the frame to be processed and a motion vector included in a right region of a frame immediately preceding the frame to be processed as the evaluation index of the right region. The evaluation index described above is merely an example, and the invention is not limited thereto. Any index may be used as long as it can evaluate a magnitude of the motion of the object included in the right region of the frame.

The annotation control unit 402 determines whether annotation data of the right region needs to be generated using the evaluation index of the right region (step S402).

Specifically, the annotation control unit 402 determines whether the evaluation index of the right region is larger than a threshold included in the compression setting information. If the evaluation index of the right region is larger than the threshold, it is determined that the annotation data of the right region needs to be generated.

If it is determined that the annotation data of the right region needs to be generated, the annotation control unit 402 generates a first execution instruction for instructing execution of the annotation data generation processing of the right region, and transmits the first execution instruction to the annotation data generation unit 403 (step S403). Thereafter, the annotation control unit 402 proceeds to step S405.

When the annotation data of the right region does not need to be generated, the annotation control unit 402 generates a first skip instruction and transmits the first skip instruction to the annotation data generation unit 403 (step S404). Thereafter, the annotation control unit 402 proceeds to step S405.

In step S405, the annotation control unit 402 determines whether the annotation data of the left region needs to be generated using the evaluation index of the left region (step S405).

Specifically, the annotation control unit 402 determines whether the evaluation index of the left region is larger than a threshold included in the compression setting information. If the evaluation index of the left region is larger than the threshold, it is determined that the annotation data of the left region needs to be generated.

If it is determined that the annotation data of the left region needs to be generated, the annotation control unit 402 generates a second execution instruction for instructing execution of the annotation data generation processing of the left region, and transmits the second execution instruction to the annotation data generation unit 403 (step S406). Thereafter, the annotation control unit 402 ends the processing.

When the annotation data of the left region does not need to be generated, the annotation control unit 402 generates a second skip instruction and transmits the second skip instruction to the annotation data generation unit 403 (step S407). Thereafter, the annotation control unit 402 ends the processing.

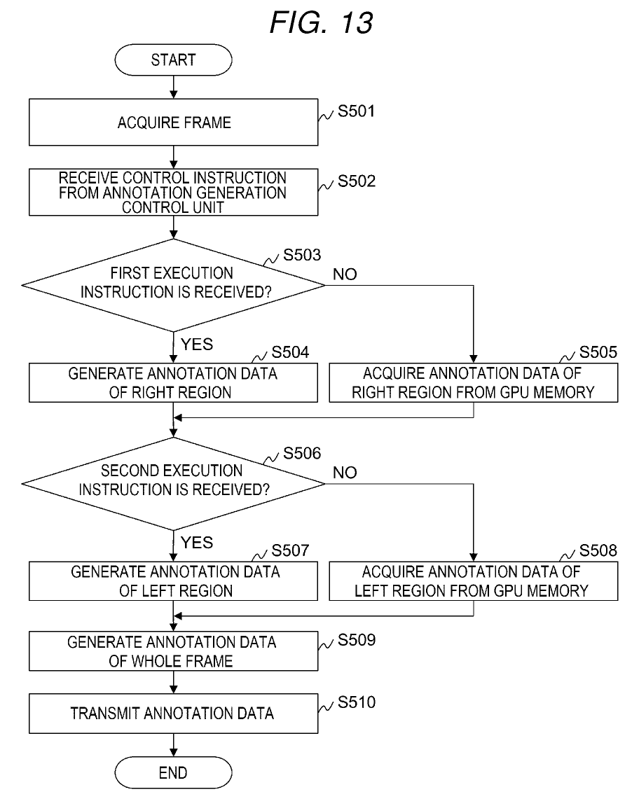

FIG. 13 is a flowchart illustrating an example of processing executed by the annotation data generation unit 403 according to Embodiment 3.

The annotation data generation unit 403 acquires the frame (step S501) and receives the control instruction from the annotation control unit 402 (step S502). In Embodiment 3, two control instructions are received.

The annotation data generation unit 403 determines whether the received control instruction is the first execution instruction (step S503).

When the received control instruction is the first execution instruction, the annotation data generation unit 403 generates annotation data of the right region by executing the annotation data generation processing using the right region of the frame (step S504). At this time, the annotation data generation unit 403 stores the annotation data of the right region in the GPU memory 400. When the annotation data of the right region is stored, the annotation data generation unit 403 overwrites the annotation data of the right region.

When the received control instruction is the first skip instruction, the annotation data generation unit 403 acquires the previous annotation data of the right region from the GPU memory 400 (step S505).

The annotation data generation unit 403 determines whether the received control instruction is the second execution instruction (step S506).

When the received control instruction is the second execution instruction, the annotation data generation unit 403 generates annotation data of the left region by executing the annotation data generation processing using the left region of the frame (step S507). At this time, the annotation data generation unit 403 stores the annotation data of the left region in the GPU memory 400. When the annotation data of the left region is stored, the annotation data generation unit 403 overwrites the annotation data of the left region.

When the received control instruction is the second skip instruction, the annotation data generation unit 403 acquires the previous annotation data of the left region from the GPU memory 400 (step S508).

The annotation data generation unit 403 integrates the annotation data of the right region and the annotation data of the left region to generate annotation data of the whole frame (step S509).

The annotation data generation unit 403 transmits the annotation data to the encoder 404 (step S510). Thereafter, the annotation data generation unit 403 ends the processing.

In Embodiment 3, since the annotation data generation processing is executed using an image having a size less than that of the entire frame, the processing load is reduced.

Although the processing has been described by dividing the frame into the two regions of the right region and the left region, the processing is not limited thereto. The similar processing may be performed by dividing the frame into any number of regions.

### Embodiment 4

In Embodiment 4, the annotation control unit 402 analyzes motion characteristics of an object in video data based on a type of the video data, and controls annotation data generation processing. Hereinafter, Embodiment 4 will be described focusing on differences from Embodiment 1.

A system configuration according to Embodiment 4 is the same as that in Embodiment 1. A configuration of the compression system 100 according to Embodiment 4 is the same as that in Embodiment 1. The configuration of Embodiment 2 may be adopted.

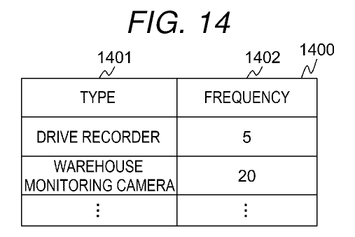

Frequency adjustment information is stored in the compression setting database 213 according to Embodiment 4. FIG. 14 is a diagram illustrating an example of a data structure of the frequency adjustment information according to Embodiment 4.

A frequency adjustment information 1400 stores entries including a type 1401 and a frequency 1402. The type 1401 is a field for storing the type of the video data. In the present embodiment, the type of the video data is represented by a device that captures the video data, a capturing environment, and the like. The frequency 1402 is a field for storing an execution frequency of the annotation data generation processing. The frequency 1402 stores the number of frames.

In video data captured by a drive recorder, it is assumed that an object moves significantly. Therefore, it is preferable to set the execution frequency of the annotation data generation processing to be high. In contrast, it is assumed that object movement does not occur often in video data captured by a camera fixed in a warehouse. Therefore, the execution frequency of the annotation data generation processing may be set low.

In Embodiment 4, it is assumed that metadata including a device, a capturing environment, and the like, is added to the video data.

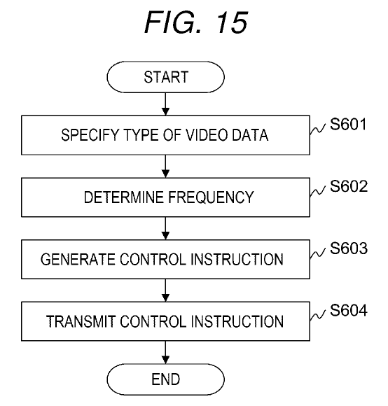

FIG. 15 is a flowchart illustrating an example of the processing executed by the annotation control unit 402 according to Embodiment 4. In Embodiment 4, the annotation control unit 402 executes processing to be described below when compression of the video data starts.

The annotation control unit 402 specifies the type of the video data based on the metadata added to the video data (step S601).

The annotation control unit 402 searches for an entry corresponding to the type of video data with reference to the frequency adjustment information 1400, and determines the frequency based on the found entry (step S602).

The annotation control unit 402 generates a control instruction including the determined frequency (step S603), and transmits the control instruction to the encoder 404 (step S604). Thereafter, the annotation control unit 402 ends the processing.

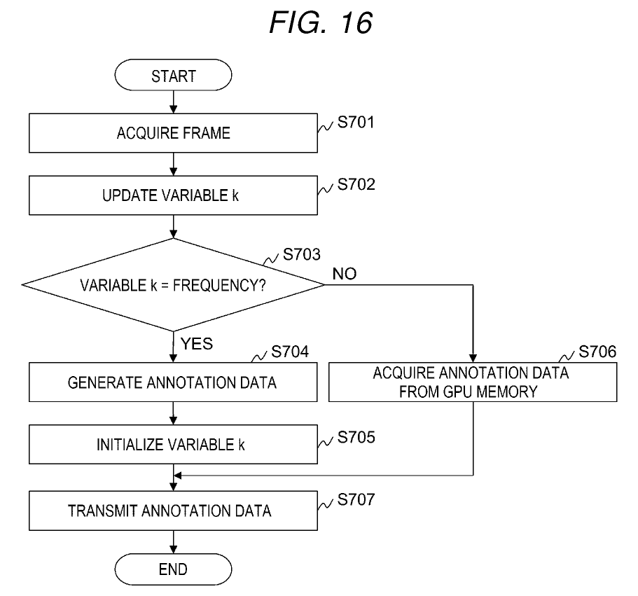

FIG. 16 is a flowchart illustrating an example of the processing executed by the annotation data generation unit 403 according to Embodiment 4.

When receiving the control instruction, the annotation data generation unit 403 according to Embodiment 4 initializes a variable k to 0. Thereafter, the annotation data generation unit 403 executes the processing to be described below.

The annotation control unit 402 acquires a frame (step S701) and adds 1 to the variable k (step S702).

The annotation data generation unit 403 determines whether the variable k matches the frequency included in the control instruction (step S703).

If the variable k matches the frequency included in the control instruction, the annotation data generation unit 403 generates the annotation data by executing the annotation data generation processing (step S704). The annotation data generation unit 403 initializes the variable k to 0 (step S705), and the annotation data generation unit 403 proceeds to step S707.

At this time, the annotation data generation unit 403 stores the annotation data in the GPU memory 400. When the annotation data is stored, the annotation data generation unit 403 overwrites the annotation data.

If the variable k does not match the frequency included in the control instruction, the annotation data generation unit 403 acquires the previous annotation data from the GPU memory 400 (step S706). Thereafter, the annotation data generation unit 403 proceeds to step S707.

The annotation data generation unit 403 transmits the annotation data to the encoder 404 (step S707). Thereafter, the annotation data generation unit 403 ends the processing.

The compression system 100 according to Embodiment 4 can analyze the motion characteristics of the object in the video data based on the type of the video data and control the execution of the annotation data generation processing based on an analysis result.

### Embodiment 5

In Embodiment 5, an annotation control unit analyzes motion characteristics of an object in video data based on a frame rate of the video data, and controls annotation data generation processing. Hereinafter, Embodiment 5 will be described focusing on differences from Embodiment 1.

A system configuration according to Embodiment 5 is the same as that in Embodiment 1. A configuration of the compression system 100 according to Embodiment 5 is the same as that in Embodiment 1. The configuration of Embodiment 2 may be adopted.

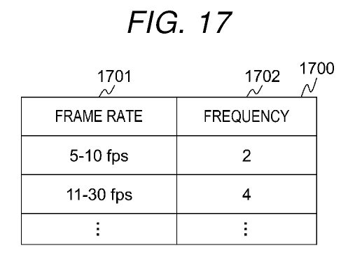

Frequency adjustment information is stored in the compression setting database 213 according to Embodiment 5. FIG. 17 is a diagram illustrating an example of a data structure of the frequency adjustment information according to Embodiment 5.

A frequency adjustment information 1700 stores entries including a frame rate 1701 and a frequency 1702. The frame rate 1701 is a field for storing the frame rate of the video data. The frequency 1702 is a field for storing execution frequency of the annotation data generation processing. The frequency 1702 stores the number of frames.

When the frame rate is high, since it is assumed that the motion of the object between frames is small, the execution frequency of the annotation data generation processing may be set low. When the frame rate is low, since it is assumed that the motion of the object between frames is large, it is preferable to set the execution frequency of the annotation data generation processing to be high.

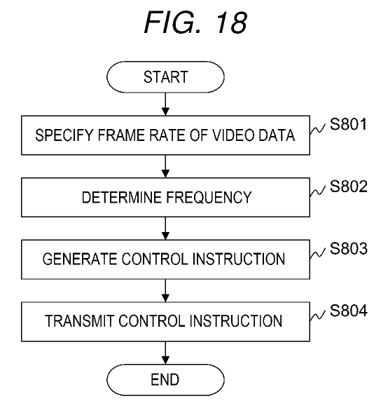

FIG. 18 is a flowchart illustrating an example of the processing executed by the annotation control unit 402 according to Embodiment 5. In Embodiment 5, the annotation control unit 402 executes processing to be described below when compression of the video data starts.

The annotation control unit 402 specifies the frame rate of the video data (step S801). A known technique may be used as a frame rate specifying method. For example, a method for adding metadata including the frame rate to the video data in advance may be considered.

The annotation control unit 402 searches for an entry corresponding to the frame rate of the video data with reference to the frequency adjustment information 1700, and determines the frequency based on the found entry (step S802).

The annotation control unit 402 generates a control instruction including the specified frequency (step S803), and transmits the control instruction to the encoder 404 (step S804). Thereafter, the annotation control unit 402 ends the processing.

Since the processing executed by the annotation data generation unit 403 according to Embodiment 5 is similar to that according to Embodiment 4, the description thereof will be omitted.

The compression system 100 according to Embodiment 5 can analyze the motion characteristics of the object in the video data based on the frame rate of the video data, and control the execution of the annotation data generation processing based on the analysis result.

The invention is not limited to the embodiments described above and includes various modifications. For example, the embodiments described above are described in detail to facilitate understanding of the invention, and the invention is not necessarily limited to those including all the described configurations. A part of a configuration in each embodiment may be added to, deleted from, or replaced with another configuration.

A part or all of the configurations, functions, processing units, processing methods, and the like described above may be implemented by hardware by, for example, designing with an integrated circuit. The invention can also be implemented by a program code of software for implementing functions of the embodiments. In this case, a storage medium storing the program code is provided to a computer, and a processor provided in the computer reads the program code stored in the storage medium. In this case, the program code read from the storage medium implements the functions of the embodiments described above by itself, and the program code itself and the storage medium storing the program code constitute the invention. Examples of the storage medium for supplying such a program code include a flexible disk, a CD-ROM, a DVD-ROM, a hard disk, a solid state drive (SSD), an optical disk, a magneto-optical disk, a CD-R, a magnetic tape, a non-volatile memory card, and a ROM.

The program code for implementing the functions described in the present embodiment can be implemented in a wide range of programs or script languages such as Assembler, C/C++, Perl, Shell, PHP, Python, and Java (registered trademark).

The program code of the software for implementing the functions in the embodiments may be distributed via a network to be stored in a storage unit such as a hard disk or a memory of a computer or a storage medium such as a CD-RW or a CD-R, and a processor provided in the computer may read and execute the program code stored in the storage unit or the storage medium.

Control lines and information lines considered to be necessary for description are shown in the embodiments described above, and not all control lines and information lines in a product are necessarily shown. All the configurations may be connected.

What is claimed is:

1. A computer system comprising:
at least one computing device; and
a storage device connected to the at least one computing device, wherein
the storage device stores video data including a plurality of frames,
the frame includes at least one object, and
the at least one computing device
analyzes a motion characteristic of the object in the video data,
controls execution of processing of generating annotation data indicating a position of an important object included in the frame based on a result of the analysis, and
compresses the frame using the annotation data such that a data amount of a region in which the important object is present is large and a data amount of a region in which the important object is not present is small.

2. The computer system according to claim 1, wherein
the at least one computing device
analyzes a magnitude of a motion of the object included in the frame, and
determines whether to execute the processing on the frame based on a result of the analysis.

3. The computer system according to claim 2, wherein
the at least one computing device
calculates an evaluation index for evaluating the magnitude of the motion of the object included in the frame using a motion vector included in the frame,
determines whether to execute the processing on the frame based on a comparison result between the evaluation index and a first threshold, and
compresses the frame using the annotation data generated by the processing, which is previously executed, when the processing is not executed on the frame.

4. The computer system according to claim 3, wherein
the at least one computing device
counts the number of times it is determined not to execute the processing on the frame, and
determines to execute the processing on the frame when the number of times is larger than a second threshold.

5. The computer system according to claim 1, wherein
the at least one computing device
analyzes a type of the video data, and
determines an execution frequency of the processing based on a result of the analysis.

6. The computer system according to claim 1, wherein
the at least one computing device
analyzes a frame rate of the video data, and
determines an execution frequency of the processing based on a result of the analysis.

7. A video data compression method executed by a computer system,
the computer system including at least one computing device, and a storage device connected to the at least one computing device,
the storage device storing video data including a plurality of frames,
the frame including at least one object, the video data compression method comprising:
a first step of analyzing a motion characteristic of the object in the video data by the at least one computing device;
a second step of controlling, by the at least one computing device, execution of processing of generating annotation data indicating a position of an important object included in the frame based on a result of the analysis; and
a third step of compressing, by the at least one computing device, the frame using the annotation data such that a data amount of a region in which the important object is present is large and a data amount of a region in which the important object is not present is small.

8. The video data compression method according to claim 7, wherein
the first step includes a step of analyzing, by the at least one computing device, a magnitude of a motion of the object included in the frame, and
the second step includes a step of determining, by the at least one computing device, whether to execute the processing on the frame based on a result of the analysis.

9. The video data compression method according to claim 8, wherein
the first step includes a step of calculating, by the at least one computing device, an evaluation index for evaluating the magnitude of the motion of the object included in the frame using a motion vector included in the frame,
the second step includes a step of determining, by the at least one computing device, whether to execute the processing on the frame based on a comparison result between the evaluation index and a first threshold, and
the third step includes a step of compressing, by the at least one computing device, the frame using the annotation data generated by the processing, which is previously executed, when the processing is not executed on the frame.

10. The video data compression method according to claim 7, wherein
the first step includes a step of analyzing, by the at least one computing device, a type of the video data, and
the second step includes a step of determining, by the at least one computing device, an execution frequency of the processing based on a result of the analysis.

11. The video data compression method according to claim 7, wherein
the first step includes a step of analyzing, by the at least one computing device, a frame rate of the video data, and
the second step includes a step of determining, by the at least one computing device, an execution frequency of the processing based on a result of the analysis.

12. A program executed by a computer that compresses video data,
the computer including at least one computing device, and a storage device connected to the at least one computing device,
the storage device storing the video data including a plurality of frames,
the frame including at least one object,
the program causing the computer to execute operations comprising:
a first procedure of analyzing a motion characteristic of the object in the video data;
a second procedure of controlling execution of processing of generating annotation data indicating a position of an important object included in the frame based on a result of the analysis; and
a third procedure of compressing the frame using the annotation data such that a data amount of a region in which the important object is present is large and a data amount of a region in which the important object is not present is small.

13. The program according to claim 12, wherein
the first procedure includes a procedure of analyzing a magnitude of a motion of the object included in the frame, and
the second procedure includes a procedure of determining whether to execute the processing on the frame based on a result of the analysis.

14. The program according to claim 13, wherein
the first procedure includes a procedure of calculating an evaluation index for evaluating the magnitude of the motion of the object included in the frame using a motion vector included in the frame,
the second procedure includes a procedure of determining whether to execute the processing on the frame based on a comparison result between the evaluation index and a first threshold, and
the third procedure includes a procedure of compressing the frame using the annotation data generated by the processing, which is previously executed, when the processing is not executed on the frame.

15. The program according to claim 12, wherein
the first procedure includes a procedure of analyzing a type of the video data, and
the second procedure includes a procedure of determining an execution frequency of the processing based on a result of the analysis.

16. The program according to claim 12, wherein
the first procedure includes a procedure of analyzing a frame rate of the video data, and
the second procedure includes a procedure of determining an execution frequency of the processing based on a result of the analysis.
